(19) United States
(12) Patent Application Publication
(10) Pub. No.: US 2026/0012024 A1
(43) Pub. Date: Jan. 8, 2026

(54) CHARGING CIRCUIT FOR BATTERY PACK AND WORKING SYSTEM OF SHIP

(71) Applicant: Guangdong Greenway Technology Co., Ltd., Dongguan (CN)

(72) Inventors: Wei WU, Dongguan (CN); Xiaoling HUANG, Dongguan (CN); Zhiping ZHANG, Dongguan (CN)

(73) Assignee: Guangdong Greenway Technology Co., Ltd., Dongguan (CN)

(21) Appl. No.: 18/925,184

(22) Filed: Oct. 24, 2024

(30) Foreign Application Priority Data
Jul. 2, 2024 (CN) 202410876783.3

(51) Int. Cl. H02J 7/00; B63B 79/40; H01M 10/42; H01M 10/46

(52) U.S. Cl. CPC H02J 7/00308; B63B 79/40; H01M 10/46; H02J 7/0045; H02J 7/0047; H02J 7/007182; H01M 2010/4271

(57) ABSTRACT

Provided are a charging circuit for a battery pack and a working system of a ship. The charging circuit includes a first switch circuit, a clamp gating circuit and a battery management circuit. The first switch circuit includes a first switch terminal, a second switch terminal and a switch control terminal. The clamp gating circuit includes a first clamp terminal, a second clamp terminal and at least one gating control terminal. The battery management circuit is configured to separately acquire charging voltages of multiple battery cells and a battery pack voltage between a first electrode and a second electrode in real time and control, according to the charging voltages and the battery pack voltage, a gating control signal supplied to each of the at least one gating control terminal and a switch control signal supplied to the switch control terminal.

### CROSS-REFERENCE TO RELATED APPLICATION(S)

This application claims priority to Chinese Patent Application No. 202410876783.3 filed Jul. 2, 2024, the disclosure of which is incorporated herein by reference in its entirety.

### TECHNICAL FIELD

The present invention relates to the field of charging protection technologies for batteries and, in particular, to a charging circuit for a battery pack and a working system of a ship.

### BACKGROUND

A working system of a ship mainly includes a start-up battery, an engine, a generator, a display instrument and other electrical equipment. The working principle of the working system is as follows: the start-up battery starts the engine, and after the engine works, the generator is driven to generate power, and electrical energy generated by the generator may charge the start-up battery in turn. The generator has a feedback adjustment mechanism for its own output voltage. When the output voltage is too high or too low, the generator performs a feedback adjustment to maintain the output voltage within a safe range. It is found in actual use that during a process of charging a lithium iron phosphate battery by the generator, if the lithium battery undergoes charging protection, and a charging switch is turned off actively, a voltage spike is generated on a charging bus due to a delayed feedback adjustment response output by the generator. When the spike is relatively high, the display instrument of the ship will be damaged.

To solve this problem, generally, a super capacitance is connected in parallel to ports of the lithium battery. The super capacitance may filter out a voltage spike to a certain extent. Meanwhile, an active equalization function is added to ensure that a voltage difference between single cells is not large and that a gap between the total battery voltage and the upper limit of the output voltage of the generator can be minimized as much as possible. When charging protection occurs, an excessive voltage spike can be prevented from being generated on a bus.

Although the parallel super capacitance and the active equalization addition may weaken the voltage spike to a certain extent, due to the very complex technology and relatively high cost, this manner is not advantageous in actual applications.

### SUMMARY

The present invention provides a charging circuit for a battery pack and a working system of a ship to suppress a spike voltage through a simple and reliable charging circuit when charging protection occurs.

According to one aspect of the present invention, a charging circuit for a battery pack is provided. The battery pack includes a first electrode, a second electrode and a plurality of battery cells electrically connected between the first electrode and the second electrode. The charging circuit includes a first switch circuit, a clamp gating circuit and a battery management circuit.

The first switch circuit includes a first switch terminal, a second switch terminal and a switch control terminal, where the first switch terminal is electrically connected to the first electrode, the second switch terminal is electrically connected to a first charging and discharging terminal of the charging circuit, and the second electrode is electrically connected to a second charging and discharging terminal of the charging circuit.

The clamp gating circuit includes a first clamp terminal, a second clamp terminal and at least one gating control terminal, where the first clamp terminal is electrically connected to the first electrode, and the second clamp terminal is electrically connected to the first charging and discharging terminal.

The battery management circuit is electrically connected to the switch control terminal and the at least one gating control terminal separately and configured to separately acquire charging voltages of the plurality of battery cells and a battery pack voltage between the first electrode and the second electrode in real time and control, according to the charging voltages and the battery pack voltage, a gating control signal supplied to each of the at least one gating control terminal and a switch control signal supplied to the switch control terminal.

The first switch circuit is configured to be turned on or off under control of the switch control signal.

The clamp gating circuit is configured to control a voltage between the first electrode and the first charging and discharging terminal according to the gating control signal.

In one or more embodiments, the clamp gating circuit includes a plurality of clamp units electrically connected between the first electrode and the first charging and discharging terminal.

A clamp unit of the plurality of clamp units at least includes a gating control terminal of the at least one gating control terminal.

The battery management circuit is configured to control, according to the charging voltages and the battery pack voltage, gating control signals supplied to gating control terminals of the plurality of clamp units separately to control on-off states of the plurality of clamp units between the first electrode and the first charging and discharging terminal.

In one or more embodiments, the plurality of clamp units are sequentially cascaded between the first electrode and the first charging and discharging terminal.

In one or more embodiments, the clamp unit further includes a clamp load and a gating switch.

Among the plurality of clamp units, in a same clamp unit, a control terminal of the gating switch is electrically connected to the gating control terminal, a first terminal of the gating switch is electrically connected to a first terminal of the clamp load, and a second terminal of the gating switch is electrically connected to the first charging and discharging terminal.

In a first-stage clamp unit, a second terminal of the clamp load is electrically connected to the first electrode; and other than the first-stage clamp unit among the plurality of clamp units, between any two adjacent clamp units, the second terminal of the clamp load in a subsequent-stage clamp unit is electrically connected to the first terminal of the clamp load in a previous-stage clamp unit.

In one or more embodiments, the plurality of clamp units are connected in parallel between the first electrode and the first charging and discharging terminal.

In one or more embodiments, the clamp unit further includes a clamp load and a gating switch.

Among the plurality of clamp units, in a same clamp unit, the clamp load is connected to the gating switch in series, and a control terminal of the gating switch is electrically connected to the gating control terminal.

In one or more embodiments, among the plurality of clamp units, clamp loads in different clamp units have different clamp voltages.

In one or more embodiments, the clamp load includes at least one diode.

In one or more embodiments, the battery management circuit is configured to: acquire the charging voltages of the plurality of battery cells in real time; acquire the battery pack voltage between the first electrode and the second electrode in response to a charging voltage of each of at least one of the plurality of battery cells greater than a preset voltage value; control, according to the battery pack voltage and a maximum input voltage of the charging circuit, the gating control signal supplied to the each of the at least one gating control terminal to enable the clamp gating circuit to clamp a voltage between the first electrode and the first charging and discharging terminal to a preset clamp voltage, where the preset clamp voltage is greater than or equal to a difference between the maximum input voltage and the battery pack voltage; and control the switch control signal supplied to the first switch circuit after the voltage between the first electrode and the first charging and discharging terminal is clamped to the preset clamp voltage to enable the first switch circuit to be turned off.

According to another aspect of the present invention, a working system of a ship is provided. The working system includes a generator and the preceding charging circuit for a battery pack.

A negative terminal of the generator is electrically connected to a first charging and discharging terminal of the charging circuit, and a positive terminal of the generator is electrically connected to a second charging and discharging terminal of the charging circuit.

In the charging circuit for a battery pack provided in the present invention, the first switch circuit is disposed between the first electrode of the battery pack and the first charging and discharging terminal of the charging circuit so that when the battery pack requires charging, the switch control signal for controlling the first switch circuit to turn on can be supplied to a control terminal of the first switch circuit through the battery management circuit, and when the battery pack finishes charging or undergoes abnormal charging, the switch control signal for controlling the first switch circuit to turn off can be supplied to the control terminal of the first switch circuit through the battery management circuit, thereby controlling a charging process of the battery pack and providing charging protection for the battery pack. Meanwhile, the clamp gating circuit is disposed between the first electrode of the battery pack and the first charging and discharging terminal of the charging circuit so that the battery management circuit can supply the gating control signal to the clamp gating circuit according to the charging voltages of the plurality of battery cells in the battery pack and the battery pack voltage of the battery pack to control the voltage between the first electrode of the battery pack and the first charging and discharging terminal of the charging circuit and so that when charging protection occurs, a spike voltage generated by turning off the first switch circuit can be suppressed and prevented from causing overvoltage damage to other electrical equipment, thereby protecting electrical equipment connected in parallel to the battery pack through a simple and reliable circuit structure and suppressing the spike through the simple and reliable circuit structure when the charging protection occurs. In this manner, the charging circuit is suitable for wide applications.

It is to be understood that the content described in this part is neither intended to identify key or important features of embodiments of the present invention nor intended to limit the scope of the present invention. Other features of the present invention are readily understood from the description provided hereinafter.

### BRIEF DESCRIPTION OF DRAWINGS

To illustrate technical solutions in embodiments of the present invention more clearly, the drawings to be used in the description of the embodiments are described below briefly. Apparently, the drawings described below illustrate part of the embodiments of the present invention, and those of ordinary skill in the art may obtain other drawings based on these drawings on the premise that no creative work is done.

FIG. 1 is a diagram illustrating the structure of a charging circuit for a battery pack according to an embodiment of the present invention.

FIG. 2 is another diagram illustrating the structure of a charging circuit for a battery pack according to an embodiment of the present invention.

FIG. 3 is yet another diagram illustrating the structure of a charging circuit for a battery pack according to an embodiment of the present invention.

FIG. 4 is yet another diagram illustrating the structure of a charging circuit for a battery pack according to an embodiment of the present invention.

FIG. 5 is yet another diagram illustrating the structure of a charging circuit for a battery pack according to an embodiment of the present invention.

FIG. 6 is a diagram illustrating the structure of a working system of a ship according to an embodiment of the present invention.

### DETAILED DESCRIPTION

For a better understanding of technical solutions of the present invention by those skilled in the art, the technical solutions in embodiments of the present invention are described below clearly and completely in conjunction with the drawings in the embodiments of the present invention. Apparently, the embodiments described below are part, not all, of the embodiments of the present invention. Based on the embodiments described herein, all other embodiments obtained by those of ordinary skill in the art on the premise that no creative work is done are within the scope of the present invention.

It is to be noted that terms such as “first” and “second” in the description, claims and above drawings of the present invention are used for distinguishing between similar objects and are not necessarily used for describing a particular order or sequence. It is to be understood that data used in this manner are interchangeable where appropriate so that the embodiments of the present invention described herein can be implemented in a sequence not illustrated or described herein. In addition, terms “including” and “having” and any variations thereof are intended to encompass a non-exclusive inclusion. For example, a process, method, system, product or apparatus that includes a series of steps or units not only includes the expressly listed steps or units but may also include other steps or units that are not expressly listed or are inherent to such a process, method, system, product or apparatus.

Embodiments of the present invention provide a charging circuit for a battery pack so that the charging circuit can control a charging process of the battery pack in a working system of a vehicle or a ship, provide charging protection for the battery pack and suppress a spike when charging protection occurs.

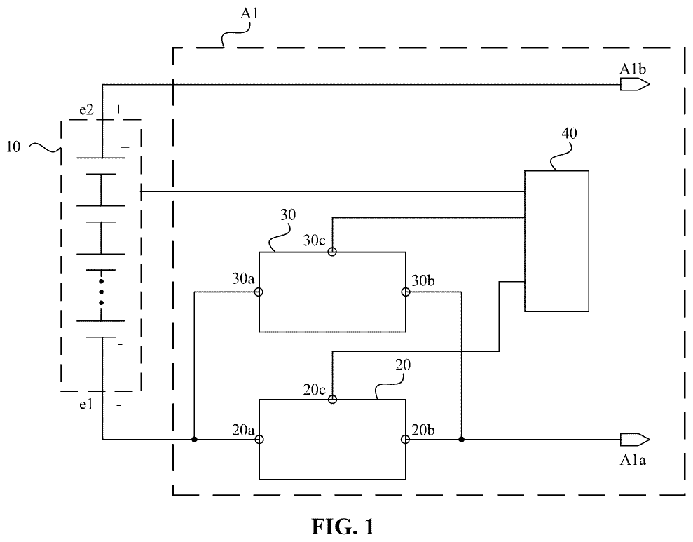

FIG. 1 is a diagram illustrating the structure of a charging circuit for a battery pack according to an embodiment of the present invention. As shown in FIG. 1, the battery pack 10 includes a first electrode e1, a second electrode e2 and multiple battery cells 11 electrically connected between the first electrode e1 and the second electrode e2, and the charging circuit A1 for a battery pack includes a first switch circuit 20, a clamp gating circuit 30 and a battery management circuit 40. The first switch circuit 20 includes a first switch terminal 20a, a second switch terminal 20b and a switch control terminal 20c, where the first switch terminal 20a is electrically connected to the first electrode e1, the second switch terminal 20b is electrically connected to a first charging and discharging terminal A1a of the charging circuit A1, and the second electrode e2 is electrically connected to a second charging and discharging terminal A1b of the charging circuit A1. The clamp gating circuit 30 includes a first clamp terminal 30a, a second clamp terminal 30b and at least one gating control terminal 30c, where the first clamp terminal 30a is electrically connected to the first electrode e1, and the second clamp terminal 30b is electrically connected to the first charging and discharging terminal A1a. The battery management circuit 40 is electrically connected to the switch control terminal 20c and the at least one gating control terminal 30c separately and configured to separately acquire charging voltages V1 of the multiple battery cells 11 and a battery pack voltage Ve between the first electrode e1 and the second electrode e2 in real time and control, according to the charging voltages V1 and the battery pack voltage Ve, a gating control signal supplied to each of the at least one gating control terminal 30c and a switch control signal supplied to the switch control terminal 20c. The first switch circuit 20 is configured to be turned on or off under control of the switch control signal. The clamp gating circuit 30 is configured to control a voltage between the first electrode e1 and the first charging and discharging terminal A1a according to the gating control signal.

If the first electrode e1 of the battery pack 10 is negative “−”, and the second electrode e2 of the battery pack 10 is positive “+”, the first charging and discharging terminal A1a is connected to a negative output terminal of a power supply apparatus to receive a negative power signal, and the second charging and discharging terminal A1b is connected to a positive output terminal of the power supply apparatus to receive a positive power signal. Alternatively, if the first electrode e1 of the battery pack 10 is positive, and the second electrode e2 of the battery pack 10 is negative, the first charging and discharging terminal A1a is connected to the positive output terminal of the power supply apparatus to receive the positive power signal, and the second charging and discharging terminal A1b is connected to the negative output terminal of the power supply apparatus to receive the negative power signal. An example in which the first electrode e1 of the battery pack 10 is negative, and the second electrode e2 of the battery pack 10 is positive is used as an example in the embodiments of the present invention for illustration.

Specifically, in the battery pack 10, the multiple battery cells 11 may be connected in series, or multiple battery cells 11 may also be connected in parallel to form a battery power group so that battery power groups can be connected in series to supply a relatively large voltage or current. The case where the multiple battery cells 11 are connected in series is illustrated in the figure. The multiple battery cells 11 in the battery pack 10 are preferably lithium iron phosphate batteries. The lithium iron phosphate batteries have the advantages of higher energy density, small volume, light weight, long service life and good environmental protection effect and are suitable for wide applications.

The first switch terminal 20a of the first switch circuit 20 is electrically connected to the first electrode e1 of the battery pack, the second switch terminal 20b of the first switch circuit 20 is electrically connected to the first charging and discharging terminal A1a of the charging circuit A1, and the battery management circuit 40 may include a switch control signal output terminal so that the switch control signal output terminal can be electrically connected to the switch control terminal 20c of the first switch circuit 20. In this manner, the battery management circuit 40 supplies the switch control signal to the first switch circuit 20 through the switch control signal output terminal to control the first switch circuit 20 to turn on or off. The second charging and discharging terminal A1b of the charging circuit A1 is electrically connected to the second electrode e2 of the battery pack 10, and the first charging and discharging terminal A1a of the charging circuit A1 and the second charging and discharging terminal A1b of the charging circuit A1 may also be connected to the power supply apparatus. When the battery pack 10 requires charging, the battery management circuit 40 may control the first switch circuit 20 to turn on so that the power supply apparatus can charge the battery pack 10 through the charging circuit A1. When the battery pack 10 is required to stop being charged, the first switch circuit 20 may be controlled to turn off so that the charging circuit A1 can be turned off, and the power supply apparatus cannot charge the battery pack 10. In the working system of a vehicle or a ship, the power supply apparatus may be a generator or may also be an inverter, a rectifier, or another power extraction apparatus in another feasible embodiment. This is not specifically limited in the embodiments of the present invention.

The clamp gating circuit 30 may be electrically connected between the first electrode e1 of the battery pack 10 and the first charging and discharging terminal A1a of the charging circuit A1 and may be considered to be connected in parallel to the first switch circuit 20 in terms of connection manner. The battery management circuit 40 may include a gating control signal output terminal so that the gating control signal output terminal can be electrically connected to the at least one gating control terminal 30c of the clamp gating circuit 30, and the gating control signal can be supplied to the clamp gating circuit 30 through the gating control signal output terminal to control a clamp voltage between the first electrode e1 of the battery pack 10 and the first charging and discharging terminal A1a of the charging circuit A1.

The battery management circuit 40 may also be electrically connected to the battery pack 10. In the charging process of the battery pack 10, the battery management circuit 40 may acquire a charging voltage V1 of each battery cell 11 in the battery pack 10 and the battery pack voltage Ve (that is, the total voltage of the battery pack 10) between the first electrode e1 of the battery pack 10 and the second electrode e2 of the battery pack 10 in real time.

As a feasible embodiment, the battery management circuit 40 may output, according to the charging voltages V1 of the multiple battery cells 11 and the battery pack voltage Ve of the battery pack 10, the gating control signal to the each of the at least one gating control terminal 30c of the clamp gating circuit 30 and the switch control signal to the switch control terminal 20c of the first switch circuit 20. Therefore, the battery management circuit 40 may control the state of the first switch circuit 20 and a voltage at two terminals of the clamp gating circuit 30. The voltage at the two terminals of the clamp gating circuit 30 is the voltage between the first electrode e1 of the battery pack 10 and the first charging and discharging terminal A1a of the charging circuit A1. In this manner, the battery management circuit 40 can control the first switch circuit 20 to turn on when charging the battery pack 10, ensuring a normal charging process of the battery pack 10 and control the first switch circuit 20 to turn off timely when abnormal charging occurs, providing charging protection for the battery pack 10. Moreover, the battery management circuit 40 may also control the voltage between the first electrode e1 of the battery pack 10 and the first charging and discharging terminal A1a of the charging circuit A1 by controlling the clamp gating circuit 30 so that a spike voltage generated by turning off the first switch circuit 20 can be suppressed when charging protection occurs, and overvoltage damage to other electrical equipment caused by the spike voltage due to a delayed response of the power supply apparatus can be avoided when the power supply apparatus simultaneously supplies power to the other electrical equipment.

In this embodiment, the first switch circuit is disposed between the first electrode of the battery pack and the first charging and discharging terminal of the charging circuit so that when the battery pack requires charging, the switch control signal for controlling the first switch circuit to turn on can be supplied to a control terminal of the first switch circuit through the battery management circuit, and when the battery pack finishes charging or undergoes abnormal charging, the switch control signal for controlling the first switch circuit to turn off can be supplied to the control terminal of the first switch circuit through the battery management circuit, thereby controlling a charging process of the battery pack and providing charging protection for the battery pack. Meanwhile, the clamp gating circuit is disposed between the first electrode of the battery pack and the first charging and discharging terminal of the charging circuit so that the battery management circuit can supply the gating control signal to the clamp gating circuit according to the charging voltages of the multiple battery cells in the battery pack and the battery pack voltage of the battery pack to control the voltage between the first electrode of the battery pack and the first charging and discharging terminal of the charging circuit and so that when charging protection occurs, the spike voltage generated by turning off the first switch circuit can be suppressed and prevented from causing overvoltage damage to other electrical equipment, thereby protecting the electrical equipment connected in parallel to the battery pack through a simple and reliable circuit structure and suppressing the spike through the simple and reliable circuit structure when the charging protection occurs. In this manner, the charging circuit is suitable for wide applications.

In one or more embodiments, referring to FIG. 1, the battery management circuit 40 is specifically configured to acquire the charging voltages V1 of the multiple battery cells 11 in real time; acquire the battery pack voltage Ve between the first electrode e1 and the second electrode e2 in response to a charging voltage V1 of each of at least one battery cell 11 greater than a preset voltage value; control, according to the battery pack voltage Ve and the maximum input voltage Vc_max of the charging circuit A1, the gating control signal supplied to the each of the at least one gating control terminal 30c to enable the clamp gating circuit 30 to clamp the voltage between the first electrode e1 and the first charging and discharging terminal A1a to a preset clamp voltage Vq, where the maximum input voltage Vc_max is the maximum voltage between the first charging and discharging terminal A1a and the second charging and discharging terminal A1b, and the preset clamp voltage is not less than a difference between the maximum input voltage Vc_max and the battery pack voltage Ve; and control the switch control signal supplied to the first switch circuit 20 after the voltage between the first electrode e1 and the first charging and discharging terminal A1a is clamped to the preset clamp voltage Vq to enable the first switch circuit 20 to be turned off.

Specifically, in the charging process of the battery pack 10, the battery management circuit 40 may acquire the charging voltages V1 of the multiple battery cells 11 in real time to monitor the charging voltages of the multiple battery cells 11 and compare the charging voltages V1 of the multiple battery cells 11 with the preset voltage value. The preset voltage value may be less than and close to the maximum charging voltage of a battery cell 11, so the first switch circuit 20 is controlled to turn off to provide charging protection for the battery pack 10 when the charging voltage of the each of the at least one battery cell 11 is equal to or greater than the maximum charging voltage. When the charging voltage of the each of the at least one battery cell 11 is greater than the preset voltage value, this indicates that the charging protection for the battery pack 10 is about to occur. At this point, the battery pack voltage Ve between the first electrode e1 of the battery pack 10 and the second electrode e2 of the battery pack 10 may be acquired to control the gating control signal supplied to the each of the at least one gating control terminal 30c according to the battery pack voltage Ve and the maximum input voltage Vc_max of the charging circuit A1. The maximum input voltage Vc_max is the maximum voltage between the first charging and discharging terminal A1a and the second charging and discharging terminal A1b and may also be construed as the maximum charging voltage that can be supplied by the power supply apparatus to the battery pack 10. The battery management circuit 40 may calculate the difference between the maximum input voltage Vc_max and the current battery pack voltage Ve of the battery pack 10 and output, according to the difference, the gating control signal to the clamp gating circuit 30 to enable the clamp gating circuit 30 to clamp the voltage between the first electrode e1 of the battery pack 10 and the first charging and discharging terminal A1a of the charging circuit A1 to the preset clamp voltage Vq. The preset clamp voltage Vq is not less than the difference between the maximum input voltage Vc_max and the battery pack voltage Ve so that the sum of the battery pack voltage Ve of the battery pack 10 and the preset clamp voltage Vq of the clamp gating circuit 30 is not less than the maximum input voltage Vc_max, that is, a voltage of a charging bus of the battery pack 10 is not less than the maximum input voltage Vc_max. In applications in which the power supply apparatus is a generator, after a voltage of the clamp gating circuit 30 is clamped to the preset clamp voltage Vq, since the voltage of the charging bus of the battery pack 10 is not less than the maximum input voltage Vc_max, the generator reduces an output voltage through a feedback adjustment. In this case, the switch control signal supplied to the first switch circuit 20 may be controlled to enable the first switch circuit 20 to be turned off. In this manner, since the output voltage of the generator is reduced, and the voltage of the charging bus of the battery pack 10 is clamped and thereby has no instant changes, the spike voltage generated when the first switch circuit 20 is turned off can be reduced greatly, that is, the generation of the spike voltage can be suppressed effectively when the battery pack 10 undergoes the charging protection.

In another feasible embodiment, after being acquired, the charging voltages V1 of the multiple battery cells 11 may be first compared to determine the maximum value (that is, the maximum charging voltage); the maximum charging voltage is compared with the preset voltage value; when the maximum charging voltage is greater than the preset voltage value, it is determined that the charging protection for the battery pack 10 is about to occur; and in this case, the battery pack voltage Ve between the first electrode e1 of the battery pack 10 and the second electrode e2 of the battery pack 10 may be acquired to control the gating control signal supplied to the each of the at least one gating control terminal 30c according to the battery pack voltage Ve and the maximum input voltage Vc_max of the charging circuit A1.

It is to be noted that circuit structures of the first switch circuit 20 and the clamp gating circuit 30 may be set according to actual requirements. This is not specifically limited in the embodiments of the present invention. The circuit structures of the first switch circuit 20 and the clamp gating circuit 30 are only illustrated below using an exemplary example.

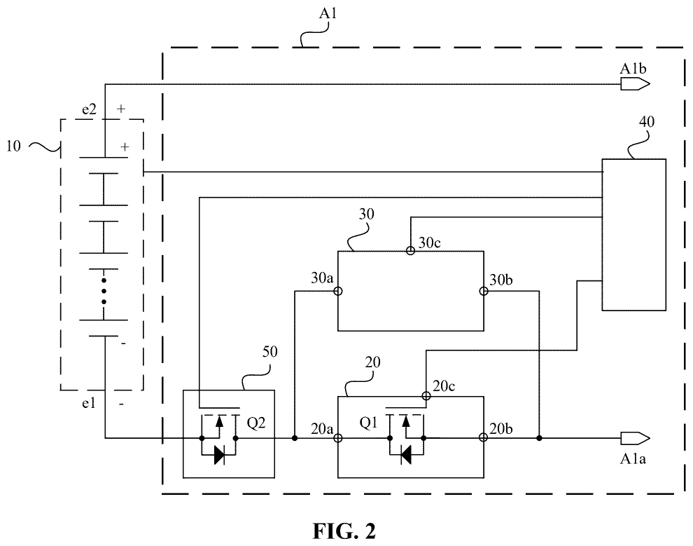

In one or more embodiments, FIG. 2 is another diagram illustrating the structure of a charging circuit for a battery pack according to an embodiment of the present invention. As shown in FIG. 2, the first switch circuit 20 may include a first transistor Q1. A first electrode of the first transistor Q1 is electrically connected to the first electrode e1 of the battery pack 10, a second electrode of the first transistor Q1 is electrically connected to the first charging and discharging terminal A1a of the charging circuit A1, and a control electrode of the first transistor Q1 is electrically connected to the switch control signal output terminal of the battery management circuit 40. The first transistor Q1 may be a charging transistor and configured to be turned off when the battery pack 10 undergoes the charging protection to avoid damage to the battery pack 10. For example, when the battery pack 10 requires charging, the battery management circuit 40 may control the first transistor Q1 to turn on so that the power supply apparatus can charge the battery pack 10 through the charging circuit A1. When the battery pack 10 is required to stop being charged, the battery management circuit 40 may control the first transistor Q1 to turn off so that the charging circuit A1 can be turned off, and the power supply apparatus cannot charge the battery pack 10.

The first transistor Q1 may be one of a field effect transistor, an insulated-gate field effect transistor, or a triode, and the channel type of the first transistor Q1 may be n-type or p-type. This is not specifically limited in the embodiments of the present invention.

Exemplarily, when the first transistor Q1 is a field effect transistor or an insulated-gate field effect transistor, the first electrode of the first transistor Q1 may be a drain of the first transistor Q1, the second electrode of the first transistor Q1 may be a source of the first transistor Q1, and the control electrode of the first transistor Q1 may be a gate of the first transistor Q1, or the first electrode of the first transistor Q1 may be a source of the first transistor Q1, the second electrode of the first transistor Q1 may be a drain of the first transistor Q1, and the control electrode of the first transistor Q1 may be a gate of the first transistor Q1. When the first transistor Q1 is a triode, the first electrode of the first transistor Q1 may be a collector electrode of the first transistor Q1, the second electrode of the first transistor Q1 may be an emitter electrode of the first transistor Q1, and the control electrode of the first transistor Q1 may be a base electrode of the first transistor Q1. When the channel type of the first transistor Q1 is n-type, the first transistor Q1 is turned on when the switch control signal received by the control electrode of the first transistor Q1 is at a high level and is turned off when the switch control signal received by the control electrode of the first transistor Q1 is at a low level. When the channel type of the first transistor Q1 is p-type, the first transistor Q1 is turned on when the switch control signal received by the control electrode of the first transistor Q1 is at a low level and is turned off when the switch control signal received by the control electrode of the first transistor Q1 is at a high level.

In one or more embodiments, with continued reference to FIG. 2, the charging circuit A1 may further include a second switch circuit 50. A control terminal of the second switch circuit 50 is electrically connected to the battery management circuit 40. The second switch circuit 50 may be disposed between the second electrode e2 of the battery pack 10 and the second charging and discharging terminal A1b of the charging circuit A1 or between the first electrode e1 of the battery pack 10 and the first charging and discharging terminal A1a of the charging circuit A1.

Specifically, the second switch circuit 50 serves as a discharging protection switch circuit of the charging circuit A1. In charging and discharging processes of the battery pack 10, the battery management circuit 40 may control the second switch circuit 50 to turn on, and if an abnormal voltage occurs in a discharging process of the battery pack 10, the battery management circuit 40 may control the second switch circuit 50 to turn off timely so that the battery pack 10 can be stopped from discharging to provide discharging protection for the battery pack 10.

It is to be understood that when the second switch circuit 50 may be connected between the first electrode e1 of the battery pack 10 and the first charging and discharging terminal A1a of the charging circuit A1, the clamp gating circuit 30 is connected in series to the second switch circuit 50 after being connected in parallel to the first switch circuit 20.

In one or more embodiments, with continued reference to FIG. 2, the second switch circuit 50 may include a second transistor Q2, that is, a discharging transistor. A first electrode of the second transistor Q2 is electrically connected to the second electrode e2 of the battery pack 10, a second electrode of the second transistor Q2 is electrically connected to the second charging and discharging terminal A1b of the charging circuit A1, and a gate of the second transistor Q2 may be electrically connected to the switch control signal output terminal of the battery management circuit 40.

Specifically, in a normal charging or a normal discharging process of the battery pack 10, the battery management circuit 40 may control the second transistor Q2 to remain turned on, and when discharging protection occurs, the battery management circuit 40 controls the second transistor Q2 to turn off to avoid damage to the battery pack 10. The second transistor Q2 may be one of a field effect transistor, an insulated-gate field effect transistor, or a triode, and the channel type of the second transistor Q2 may be n-type or p-type. This is not specifically limited in the embodiments of the present invention.

It is to be understood that after the battery pack 10 finishes charging, the first switch circuit 20 and the second switch circuit 50 may be controlled to turn off, or one of the first switch circuit 20 or the second switch circuit 50 may also be controlled to turn off. This is not specifically limited in the embodiments of the present invention.

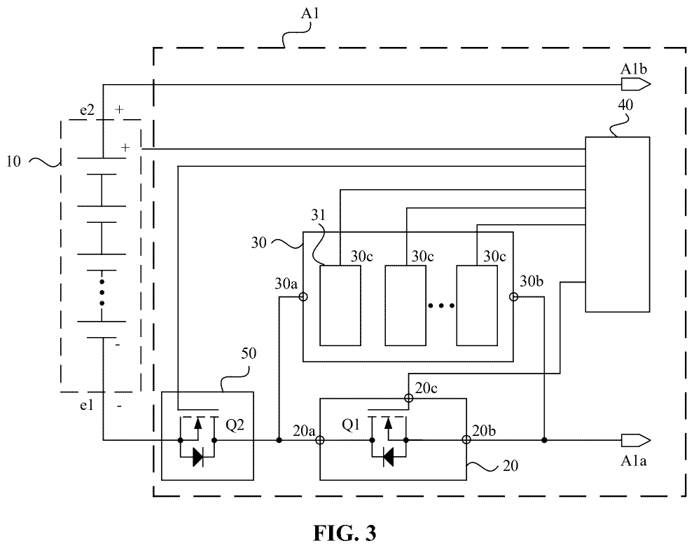

In one or more embodiments, FIG. 3 is yet another diagram illustrating the structure of a charging circuit for a battery pack according to an embodiment of the present invention. As shown in FIG. 3, the clamp gating circuit 30 includes multiple clamp units 31 electrically connected between the first electrode e1 and the first charging and discharging terminal A1a. A clamp unit 31 at least includes a gating control terminal 30c. The battery management circuit 40 is specifically configured to control, according to the charging voltages V1 and the battery pack voltage Ve, gating control signals supplied to gating control terminals 30c of the multiple clamp units 31 separately to control on-off states of the multiple clamp units 31 between the first electrode e1 and the first charging and discharging terminal A1a.

Specifically, the clamp gating circuit 30 may be formed by the multiple clamp units 31, and the multiple clamp units 31 are electrically connected between the first electrode e1 of the battery pack 10 and the first charging and discharging terminal A1a. Each clamp unit 31 at least includes the gating control terminal 30c. The battery management circuit 40 may include gating control signal output terminals in a one-to-one correspondence with the gating control terminals 30c so that the gating control signal output terminals can be connected to the gating control terminals 30c of the multiple clamp units 31 respectively to independently control the multiple clamp units 31. In this case, the battery management circuit 40 may supply the gating control signals to the gating control terminals 30c of the multiple clamp units 31 according to the charging voltages V1 of the multiple battery cells 11 and the battery pack voltage Ve of the battery pack 10 that are acquired in real time so that the on-off states of the multiple clamp units 31 between the first electrode e1 of the battery pack 10 and the first charging and discharging terminal A1a of the charging circuit A1 can be controlled separately, thereby controlling clamp voltages between the first electrode e1 of the battery pack 10 and the first charging and discharging terminal A1a of the charging circuit A1.

In another feasible embodiment, the number of gating control signal output terminals of the battery management circuit 40 may be less than the number of gating control terminals 30c so that one control signal output terminal can be connected to gating control terminals 30c of multiple clamp units 31. For example, the battery management circuit 40 may only include one gating control signal output terminal so that the gating control signal output terminal can be electrically connected to the gating control terminals 30c of the multiple clamp units 31, thereby controlling the multiple clamp units 31 in batch. Unless otherwise specified, in the embodiments of the present invention, preferably, the battery management circuit 40 includes the gating control signal output terminals in a one-to-one correspondence with the gating control terminals 30c, and the gating control signal output terminals are connected to the gating control terminals 30c of the multiple clamp units 31 respectively.

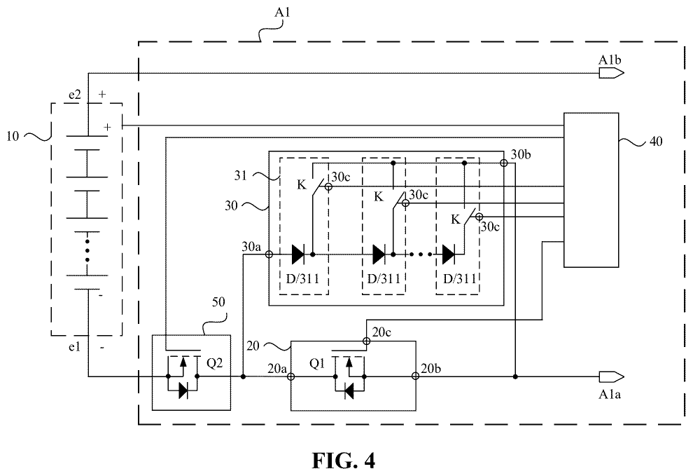

In one or more embodiments, FIG. 4 is yet another diagram illustrating the structure of a charging circuit for a battery pack according to an embodiment of the present invention. As shown in FIG. 4, the multiple clamp units 31 are sequentially cascaded between the first electrode e1 and the first charging and discharging terminal A1a.

Specifically, the multiple clamp units 31 may be disposed in a cascade manner between the first electrode e1 of the battery pack 10 and the first charging and discharging terminal A1a of the charging circuit A1, and the gating control terminals 30c of the multiple clamp units 31 may control the multiple clamp units 31 to turn on or off so that the number of clamp units 31 connected between the first electrode e1 of the battery pack 10 and the first charging and discharging terminal A1a of the charging circuit A1 can be controlled, thereby controlling the clamp voltages between the first electrode e1 of the battery pack 10 and the first charging and discharging terminal A1a of the charging circuit A1.

In one or more embodiments, referring to FIG. 4, the clamp unit 31 further includes a clamp load 311 and a gating switch K; in the same clamp unit 31, a control terminal of the gating switch K is electrically connected to the gating control terminal 30c, a first terminal of the gating switch K is electrically connected to a first terminal of the clamp load 311, and a second terminal of the gating switch K is electrically connected to the first charging and discharging terminal A1a; in a first-stage clamp unit 31, the second terminal of the clamp load 311 is electrically connected to the first electrode e1; and other than the first-stage clamp unit 31, between any two adjacent clamp units 31, the second terminal of the clamp load 311 in a subsequent-stage clamp unit 31 is electrically connected to the first terminal of the clamp load 311 in a previous-stage clamp unit 31.

Specifically, in the same clamp unit 31, the clamp load 311 and the gating switch K are successively connected in series between the first electrode e1 of the battery pack 10 and the first charging and discharging terminal A1a of the charging circuit A1, and clamp loads 311 of the multiple clamp units 31 are successively electrically connected between the first electrode e1 of the battery pack 10 and the first charging and discharging terminal A1a of the charging circuit A1 so that among the multiple clamp units 31, the second terminal of the clamp load 311 in the subsequent-stage clamp unit 31 can be electrically connected to the first terminal of the clamp load 311 in the previous-stage clamp unit 31, and the second terminal of the clamp load 311 in the first-stage clamp unit 31 can be electrically connected to the first electrode e1. In this manner, states of gating switches K are controlled so that the number of clamp loads 311 in the clamp gating circuit 30 connected between the first electrode e1 of the battery pack 10 and the first charging and discharging terminal A1a of the charging circuit A1 can be controlled, thereby controlling the clamp voltages between the first electrode e1 of the battery pack 10 and the first charging and discharging terminal A1a of the charging circuit A1.

As a feasible embodiment, if the gating switch K in the first-stage clamp unit 31 is controlled to turn on while gating switches K in other clamp units 31 are controlled to turn off, in the first-stage clamp unit 31, the second terminal of the clamp load 311 is electrically connected to the first electrode e1 of the battery pack 10, and the first terminal of the clamp load 311 is electrically connected to the first charging and discharging terminal A1a of the charging circuit A1 through the gating switch K. That is, only one clamp load 311 in the clamp gating circuit 30 is connected between the first electrode e1 of the battery pack 10 and the first charging and discharging terminal A1a of the charging circuit A1. Therefore, in this case, the clamp voltages between the first electrode e1 of the battery pack 10 and the first charging and discharging terminal A1a of the charging circuit A1 are voltages at two terminals of the one clamp load 311. If the gating switch K in a second-stage clamp unit 31 is controlled to turn on while gating switches K in other clamp units 31 are controlled to turn off, the clamp load 311 in the first-stage clamp unit 31 and the clamp load 311 in the second-stage clamp unit 31 are electrically connected between the first electrode e1 of the battery pack 10 and the first charging and discharging terminal A1a of the charging circuit A1. That is, two clamp loads 311 in the clamp gating circuit 30 are connected between the first electrode e1 of the battery pack 10 and the first charging and discharging terminal A1a of the charging circuit A1. Therefore, in this case, the clamp voltages between the first electrode e1 of the battery pack 10 and the first charging and discharging terminal A1a of the charging circuit A1 are voltages at two terminals of the two clamp loads 311. In this manner, on-off states of the gating switches K in the multiple clamp units 31 may be controlled so that the number of clamp loads 311 connected between the first electrode e1 of the battery pack 10 and the first charging and discharging terminal A1a of the charging circuit A1 can be controlled, thereby controlling the clamp voltages between the first electrode e1 of the battery pack 10 and the first charging and discharging terminal A1a of the charging circuit A1.

Specific structures of the clamp load 311 and the gating switch K may be designed according to actual requirements. This is not specifically limited in the embodiments of the present invention. In one or more embodiments, referring to FIG. 4, the clamp load 311 may include at least one diode D, that is, the clamp load 311 may include one or more diodes D, and when the clamp load 311 includes multiple diodes, the multiple diodes may be connected in parallel or in series, which is not specifically limited in the embodiments of the present invention; and the gating switch K may include a three-terminal switching device such as a gating switch or a delay.

Exemplarily, when the clamp load 311 includes only one diode D, in the same clamp load 311, the first terminal of the gating switch K may be electrically connected to a cathode of the diode D, and the second terminal of the gating switch K may be electrically connected to the first charging and discharging terminal A1a of the charging circuit A1. Among the multiple clamp units 31, an anode of the diode D in the subsequent-stage clamp unit 31 is electrically connected to the cathode of the diode D in the previous-stage clamp unit 31, the anode of the diode D in the first-stage clamp unit 31 is electrically connected to the first electrode e1 of the battery pack 10, and the cathode of the diode D in a last-stage clamp unit 31 is electrically connected to the first charging and discharging terminal A1a of the charging circuit A1. Therefore, the on-off states of the gating switches K may be controlled so that the number of diodes D connected between the first electrode e1 of the battery pack 10 and the first charging and discharging terminal A1a of the charging circuit A1 can be controlled, and the clamp voltages between the first electrode e1 of the battery pack 10 and the first charging and discharging terminal A1a of the charging circuit A1 are the sum of voltage drops of multiple diodes D connected between the first electrode e1 of the battery pack 10 and the first charging and discharging terminal A1a of the charging circuit A1.

As a feasible embodiment, when a voltage drop of the diode D in each clamp load 311 is 0.7 V, and the maximum input voltage Vc_max of the charging circuit A1 is 16 V, in the charging process of the battery pack 10, if the charging protection is about to occur when the battery pack voltage Ve between the first electrode e1 of the battery pack 10 and the second electrode e2 of the battery pack 10 is 14 V, it may be determined that the voltage difference between the maximum input voltage Vc_max and the battery pack voltage Ve is 2 V. In this case, the gating switch K in a third-stage clamp unit 31 may be controlled to turn on, so the diode D in the first-stage clamp unit 31, the diode D in the second-stage clamp unit 31 and the diode D in the third-stage clamp unit 31 are successively electrically connected between the first electrode e1 of the battery pack 10 and the first charging and discharging terminal A1a of the charging circuit A1. Therefore, the voltage drop at the two terminals of the clamp gating circuit 30 is 2.1 V, that is, the voltages between the first electrode e1 of the battery pack 10 and the first charging and discharging terminal A1a of the charging circuit A1 are clamped to 2.1 V greater than the voltage difference 2 V between the maximum input voltage Vc_max and the battery pack voltage Ve, so that the sum of the battery pack voltage Ve between the first electrode e1 of the battery pack 10 and the second electrode e2 of the battery pack 10 and the voltage drop at the two terminals of the clamp gating circuit 30 can be 16.1 V greater than the maximum input voltage 16 V. Using the power supply apparatus being the generator as an example, when a voltage of an output voltage bus of the generator is greater than 16 V, the output voltage is reduced through a feedback adjustment, and then the first switch circuit 20 is controlled to turn off so that while the charging protection can be provided for the battery pack 10, the spike voltage generated by turning off the first switch circuit 20 can be avoided, thereby preventing the spike voltage from damaging other electrical equipment of the generator.

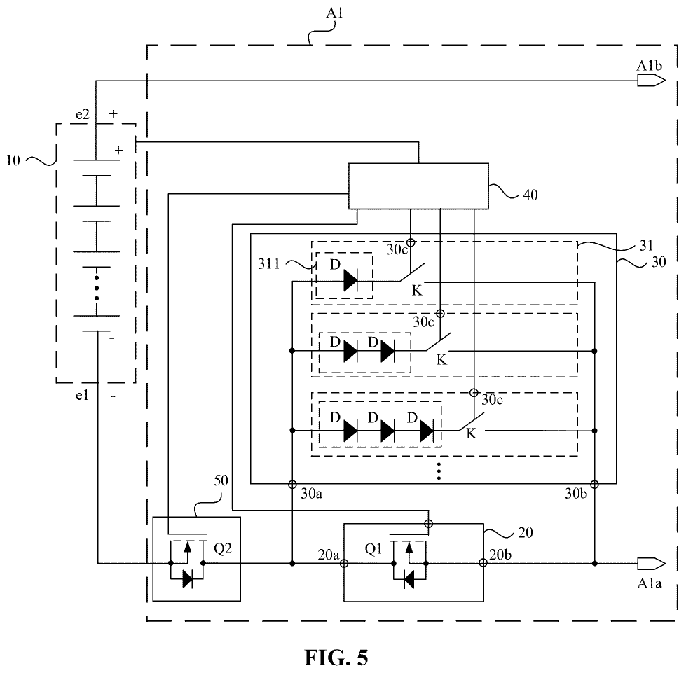

In one or more embodiments, FIG. 5 is yet another diagram illustrating the structure of a charging circuit for a battery pack according to an embodiment of the present invention. As shown in FIG. 5, the multiple clamp units 31 are connected in parallel between the first electrode e1 and the first charging and discharging terminal A1a.

Specifically, when the multiple clamp units 31 are connected in parallel between the first electrode e1 and the first charging and discharging terminal A1a, the battery management circuit 40 may control the multiple clamp units 31 to turn off or be connected between the first electrode e1 of the battery pack 10 and the first charging and discharging terminal A1a of the charging circuit A1 by controlling the gating control signals supplied to the gating control terminals of the multiple clamp units 31. Clamp loads 311 in different clamp units 31 may have the same clamp voltage or different clamp voltages. Exemplarily, if the clamp loads 311 in the different clamp units 31 have the different clamp voltages, when the charging protection for the battery pack 10 is about to occur, according to the maximum input voltage of the charging circuit A1 and the current battery pack voltage of the battery pack 10, a proper clamp unit 31 is selected to be connected between the first electrode e1 of the battery pack 10 and the first charging and discharging terminal A1a of the charging circuit A1.

In one or more embodiments, referring to FIG. 5, the clamp unit 31 further includes the clamp load 311 and the gating switch K; and in the same clamp unit 31, the clamp load 311 is connected in series to the gating switch K, and the control terminal of the gating switch K is electrically connected to the gating control terminal 30c. In this manner, the on-off states of the gating switches K may be controlled so that a situation in which the multiple clamp loads 311 are connected between the first electrode e1 of the battery pack 10 and the first charging and discharging terminal A1a of the charging circuit A1 can be controlled. For example, when the gating switch K is turned on, the clamp load 311 connected in series to the gating switch K is connected between the first electrode e1 of the battery pack 10 and the first charging and discharging terminal A1a of the charging circuit A1, and when the gating switch K is turned off, the clamp load 311 connected in series to the gating switch K is not connected between the first electrode e1 of the battery pack 10 and the first charging and discharging terminal A1a of the charging circuit A1.

Exemplarily, the numbers of diodes D included in clamp loads 311 in different clamp units 31 may be different to enable clamp voltages of the clamp loads 311 in the different clamp units 31 to be different. When the clamp load 311 includes multiple diodes D, the multiple diodes D may be successively connected in series, that is, an anode of a subsequent-stage diode D is electrically connected to a cathode of a previous-stage diode D, an anode of a first-stage diode D is electrically connected to the first electrode e1 of the battery pack 10, and a cathode of a last-stage diode D is electrically connected to the first charging and discharging terminal A1a of the charging circuit A1 through the gating switch K; or an anode of a first-stage diode D is electrically connected to the first electrode e1 of the battery pack 10 through the gating switch K, and a cathode of a last-stage diode D is electrically connected to the first charging and discharging terminal A1a of the charging circuit A1. In this manner, when the charging protection for the battery pack 10 is about to occur, according to the maximum input voltage of the charging circuit A1 and the current battery pack voltage of the battery pack 10, a proper clamp unit 31 is selected to be connected between the first electrode e1 of the battery pack 10 and the first charging and discharging terminal A1a of the charging circuit A1 so that a clamp voltage of the clamp load 311 in the clamp unit 31 (that is, a voltage at two terminals of the clamp load 311) can match a required clamp voltage (that is, the preset clamp voltage Vq), thereby clamping the voltages between the first electrode e1 of the battery pack 10 and the first charging and discharging terminal A1a of the charging circuit A1 to ensure that the generation of the spike voltage can be effectively suppressed when the first switch circuit 20 is turned off.

Exemplarily, when the battery management circuit 40 controls the gating switches K in the multiple clamp units 31 to turn on, preferably, the gating switches K are turned on in a time-sharing manner to ensure the accuracy of clamp voltages at the two terminals of the clamp gating circuit 30.

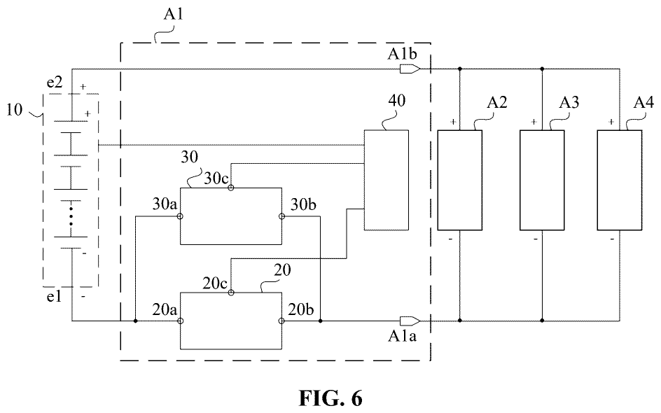

Based on the same inventive concept, embodiments of the present invention further provide a working system of a ship. FIG. 6 is a diagram illustrating the structure of a working system of a ship according to an embodiment of the present invention. As shown in FIG. 6, the working system of a ship includes a generator A2 and the charging circuit A1 for a battery pack provided in any one of the embodiments of the present invention. Therefore, the working system of a ship provided in the embodiments of the present invention includes the technical features of the charging circuit A1 for a battery pack provided in any one of the embodiments of the present invention and can achieve the beneficial effects of the charging circuit A1 for a battery pack provided in any one of the embodiments of the present invention. For similarities, references can be made to the preceding description of the charging circuit A1 for a battery pack provided in the embodiments of the present invention. Details are not repeated herein.

Referring to FIG. 6, a negative terminal “−” of the generator A2 is electrically connected to a first charging and discharging terminal A1a of the charging circuit A1, and a positive terminal “+” of the generator A2 is electrically connected to a second charging and discharging terminal A1b of the charging circuit A1. In this manner, when the generator A2 generates power, power can be supplied to other electrical equipment in the battery pack 10 and the working system of a ship.

Exemplarily, an output voltage of the generator may range from 11 V to 16 V, and when an output bus voltage of the generator is less than 11 V, the output voltage of the generator is increased through a feedback adjustment function of the generator; and when the output voltage of the generator is greater than 16 V, the output voltage of the generator may be reduced through the feedback adjustment function to achieve a relatively stable voltage output.

In one or more embodiments, with continued reference to FIG. 6, the working system of a ship further includes an engine A3 and an instrument A4; the battery pack 10 and/or the generator A2 are further configured to supply power to the engine A3 and the instrument A4; and after being started to operate, the engine A3 is configured to drive the generator A2 to generate power.

Specifically, both a negative terminal “−” of the engine A3 and a negative terminal “−” of the instrument A4 may be electrically connected to the first charging and discharging terminal A1a of the charging circuit A1 and the negative terminal “−” of the generator A2, and both a positive terminal “+” of the engine A3 and a positive terminal “+” of the instrument A4 may be electrically connected to the second charging and discharging terminal A1b of the charging circuit A1 and the positive terminal “+” of the generator A2. When the engine A3 is not started to operate, the battery pack 10 may supply power to an electrical equipment such as the instrument A4. When the engine A3 is required to be started, the battery pack 10 may supply a start voltage and a start current to the engine A3 to enable the engine A3 to be successfully started. After the engine A3 is started to operate, the engine A3 may no longer require power from the battery pack 10 and drive the generator A2 to generate power. At this point, the generator A2 may supply power to the electrical equipment such as the instrument A4, or the generator A2 and the battery pack 10 may jointly supply power to the electrical equipment such as the instrument A4. When the power of the battery pack 10 is too low, the discharging process of the battery pack 10 may be stopped, and the generator A2 charges the battery pack 10 through the charging circuit A1.

It is to be understood that various forms of the preceding flows may be used, with steps reordered, added or removed. For example, the steps described in the present invention may be performed in parallel, in sequence or in a different order as long as the desired results of the technical solutions of the present invention can be achieved. The execution sequence of these steps is not limited herein.

The preceding embodiments are not intended to limit the scope of the present invention. It is to be understood by those skilled in the art that various modifications, combinations, sub-combinations and substitutions may be made according to design requirements and other factors. Any modification, equivalent substitution or improvement made within the spirit and principle of the present invention falls within the scope of the present invention.

What is claimed is:

1. A charging circuit for a battery pack, wherein the battery pack comprises a first electrode, a second electrode and a plurality of battery cells electrically connected between the first electrode and the second electrode; and the charging circuit comprises:
a first switch circuit comprising a first switch terminal, a second switch terminal and a switch control terminal, wherein the first switch terminal is electrically connected to the first electrode, the second switch terminal is electrically connected to a first charging and discharging terminal of the charging circuit, and the second electrode is electrically connected to
a second charging and discharging terminal of the charging circuit;
a clamp gating circuit comprising a first clamp terminal, a second clamp terminal and at least one gating control terminal, wherein the first clamp terminal is electrically connected to the first electrode, and the second clamp terminal is electrically connected to the first charging and discharging terminal; and
a battery management circuit electrically connected to the switch control terminal and the at least one gating control terminal separately, and configured to separately acquire charging voltages of the plurality of battery cells and a battery pack voltage between the first electrode and the second electrode in real time and control, according to the charging voltages of the plurality of battery cells and the battery pack voltage, a gating control signal supplied to each of the at least one gating control terminal and a switch control signal supplied to the switch control terminal,
wherein the first switch circuit is configured to be turned on or off under control of the switch control signal; and
wherein the clamp gating circuit is configured to control a voltage between the first electrode and the first charging and discharging terminal according to the gating control signal.

2. The charging circuit according to claim 1, wherein the clamp gating circuit comprises a plurality of clamp units electrically connected between the first electrode and the first charging and discharging terminal;
each clamp unit of the plurality of clamp units at least comprises a gating control terminal of the at least one gating control terminal; and
the battery management circuit is configured to control, according to the charging voltages of the plurality of battery cells and the battery pack voltage, gating control signals supplied to gating control terminals of the plurality of clamp units separately to control on-off states of the plurality of clamp units between the first electrode and the first charging and discharging terminal.

3. The charging circuit according to claim 2, wherein the plurality of clamp units are sequentially cascaded between the first electrode and the first charging and discharging terminal.

4. The charging circuit according to claim 3, wherein each clamp unit of the plurality of clamp units further comprises a clamp load and a gating switch;
among the plurality of clamp units, in a same clamp unit, a control terminal of the gating switch is electrically connected to the gating control terminal, a first terminal of the gating switch is electrically connected to a first terminal of the clamp load, and a second terminal of the gating switch is electrically connected to the first charging and discharging terminal; and
in a first-stage clamp unit of the plurality of clamp units, a second terminal of the clamp load is electrically connected to the first electrode; and
among the plurality of clamp units excluding the first-stage clamp unit, between any two adjacent clamp units, the second terminal of the clamp load in a subsequent-stage clamp unit of the any two adjacent clamp units is electrically connected to the first terminal of the clamp load in a previous-stage clamp unit of the any two adjacent clamp units.

5. The charging circuit according to claim 2, wherein the plurality of clamp units are connected in parallel between the first electrode and the first charging and discharging terminal.

6. The charging circuit according to claim 5, wherein each clamp unit of the plurality of clamp units further comprises a clamp load and a gating switch; and
among the plurality of clamp units, in a same clamp unit, the clamp load is connected in series to the gating switch, and a control terminal of the gating switch is electrically connected to the gating control terminal.

7. The charging circuit according to claim 6, wherein among the plurality of clamp units, clamp loads in different clamp units have different clamp voltages.

8. The charging circuit according to claim 4, wherein the clamp load comprises at least one diode.

9. The charging circuit according to claim 1, wherein the battery management circuit is configured to:
acquire the charging voltages of the plurality of battery cells in real time;
acquire the battery pack voltage between the first electrode and the second electrode in response to a charging voltage of at least one of the plurality of battery cells greater than a preset voltage value;
control, according to the battery pack voltage and a maximum input voltage of the charging circuit, the gating control signal supplied to each of the at least one gating control terminal to enable the clamp gating circuit to clamp a voltage between the first electrode and the first charging and discharging terminal to a preset clamp voltage, wherein the preset clamp voltage is greater than or equal to a difference between the maximum input voltage and the battery pack voltage; and
control the switch control signal supplied to the first switch circuit to enable the first switch circuit to be turned off after the voltage between the first electrode and the first charging and discharging terminal is clamped to the preset clamp voltage.

10. The charging circuit according to claim 6, wherein the clamp load comprises at least one diode.

11. A working system of a ship, comprising a generator and a charging circuit for a battery pack, wherein a negative terminal of the generator is electrically connected to a first charging and discharging terminal of the charging circuit, and a positive terminal of the generator is electrically connected to a second charging and discharging terminal of the charging circuit, wherein the battery pack comprises a first electrode, a second electrode and a plurality of battery cells electrically connected between the first electrode and the second electrode; and the charging circuit comprises:
a first switch circuit comprising a first switch terminal, a second switch terminal and a switch control terminal, wherein the first switch terminal is electrically connected to the first electrode, the second switch terminal is electrically connected to a first charging and discharging terminal of the charging circuit, and the second electrode is electrically connected to a second charging and discharging terminal of the charging circuit;
a clamp gating circuit comprising a first clamp terminal, a second clamp terminal and at least one gating control terminal, wherein the first clamp terminal is electrically connected to the first electrode, and the second clamp terminal is electrically connected to the first charging and discharging terminal; and
a battery management circuit electrically connected to the switch control terminal and the at least one gating control terminal separately, and configured to separately acquire charging voltages of the plurality of battery cells and a battery pack voltage between the first electrode and the second electrode in real time and control, according to the charging voltages of the plurality of battery cells and the battery pack voltage, a gating control signal supplied to each of the at least one gating control terminal and a switch control signal supplied to the switch control terminal,
wherein the first switch circuit is configured to be turned on or off under control of the switch control signal, and
wherein the clamp gating circuit is configured to control a voltage between the first electrode and the first charging and discharging terminal according to the gating control signal.

12. The working system according to claim 11, wherein the clamp gating circuit comprises a plurality of clamp units electrically connected between the first electrode and the first charging and discharging terminal;
each clamp unit of the plurality of clamp units at least comprises a gating control terminal of the at least one gating control terminal; and
the battery management circuit is configured to control, according to the charging voltages of the plurality of battery cells and the battery pack voltage, gating control signals supplied to gating control terminals of the plurality of clamp units separately to control on-off states of the plurality of clamp units between the first electrode and the first charging and discharging terminal.

13. The working system according to claim 12, wherein the plurality of clamp units are sequentially cascaded between the first electrode and the first charging and discharging terminal.

14. The working system according to claim 13, wherein each clamp unit of the plurality of clamp units further comprises a clamp load and a gating switch;
among the plurality of clamp units, in a same clamp unit, a control terminal of the gating switch is electrically connected to the gating control terminal, a first terminal of the gating switch is electrically connected to a first terminal of the clamp load, and a second terminal of the gating switch is electrically connected to the first charging and discharging terminal; and
in a first-stage clamp unit of the plurality of clamp units, a second terminal of the clamp load is electrically connected to the first electrode; and
among the plurality of clamp units excluding the first-stage clamp unit, between any two adjacent clamp units, the second terminal of the clamp load in a subsequent-stage clamp unit of the any two adjacent clamp units is electrically connected to the first terminal of the clamp load in a previous-stage clamp unit of the any two adjacent clamp units.

15. The working system according to claim 12, wherein the plurality of clamp units are connected in parallel between the first electrode and the first charging and discharging terminal.

16. The working system according to claim 15, wherein each clamp unit of the plurality of clamp units further comprises a clamp load and a gating switch; and
among the plurality of clamp units, in a same clamp unit, the clamp load is connected in series to the gating switch, and a control terminal of the gating switch is electrically connected to the gating control terminal.

17. The working system according to claim 16, wherein among the plurality of clamp units, clamp loads in different clamp units have different clamp voltages.

18. The working system according to claim 14, wherein the clamp load comprises at least one diode.

19. The working system according to claim 11, wherein the battery management circuit is configured to:
acquire the charging voltages of the plurality of battery cells in real time;
acquire the battery pack voltage between the first electrode and the second electrode in response to a charging voltage of at least one of the plurality of battery cells greater than a preset voltage value;
control, according to the battery pack voltage and a maximum input voltage of the charging circuit, the gating control signal supplied to each of the at least one gating control terminal to enable the clamp gating circuit to clamp a voltage between the first electrode and the first charging and discharging terminal to a preset clamp voltage, wherein the preset clamp voltage is greater than or equal to a difference between the maximum input voltage and the battery pack voltage; and
control the switch control signal supplied to the first switch circuit to enable the first switch circuit to be turned off after the voltage between the first electrode and the first charging and discharging terminal is clamped to the preset clamp voltage.

20. The working system according to claim 16, wherein the clamp load comprises at least one diode.
